(19) United States
(12) Patent Application Publication
(10) Pub. No.: US 2026/0101391 A1
(43) Pub. Date: Apr. 9, 2026

(54) METHODS OF BEARER MAPPING AND QUALITY OF SERVICE CONFIGURATION FOR LAYER 2 UE-TO-UE RELAY

(71) Applicant: Apple Inc., Cupertino, CA (US)

(72) Inventors: Zhibin Wu, Los Altos, CA (US); Peng Cheng, Beijing (CN); Sudeep Manithara Vamanan, Uttenreuth, Bavaria-Bayern (DE); Fangli Xu, Beijing (CN); Yuqin Chen, Beijing (CN); Haijing Hu

(21) Appl. No.: 19/112,404

(22) PCT Filed: Sep. 26, 2022
(86) PCT No.: PCT/CN2022/121304

§ 371 Date: Mar. 17, 2025

(51) Int. Cl. H04W 76/14; H04W 8/00; H04W 88/04

(52) U.S. Cl. CPC H04W 76/14; H04W 8/005; H04W 88/04

(57) ABSTRACT

A user equipment (UE) includes a transceiver and a processor configured to discover a relay-UE that provides a UE-to-UE (U2U) relay service, and establish a PC5 link with the discovered relay-UE. The processor is configured to receive, over the PC5 link and from the relay-UE, a configuration that corresponds to transport traffic of at least one end-to-end (E2E) sidelink data radio bearer (SL-DRB), and select, based on the received configuration, at least one PC5 radio link control (RLC) channel between the UE and the relay-UE to transport traffic of the at least one E2E SL-DRB to another UE. The processor is configured to transmit the E2E user plane traffic via the at least one SL-DRB.

### TECHNICAL FIELD

This application relates generally to wireless communication systems, including methods and systems for various enhancements for transmission of end-to-end (E2E) user plane traffic between remote user equipments (UEs) via a sidelink relay, or a layer-2 UE-to-UE (U2U) relay.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In some deployments, the E-UTRAN may also implement NR RAT. In some deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates an example of U2U protocol stacks, according to embodiments described herein.

FIG. 3 illustrates an example message flow between remote UEs via a U2U relay-UE for transmission of end-to-end (E2E) user plane traffic, according to embodiments described herein.

FIG. 4 illustrates an example message flow corresponding to configuration of a radio link control (RLC) channel of a PC5 interface (PC5 RLC channel) between a remote UE and a U2U relay-UE, according to embodiments described herein.

FIG. 5 illustrates an example flow-chart of operations that may be performed by a UE (or a remote UE), according to embodiments described herein.

FIG. 6 illustrates an example flow-chart of operations that may be performed by a relay-UE (or a U2U relay-UE), according to embodiments described herein.

FIG. 7 illustrates an example architecture of a wireless communication system, according to embodiments described herein.

FIG. 8 illustrates a system for performing signaling between a wireless device and a network device, according to embodiments described herein.

### DETAILED DESCRIPTION

In the present disclosure, various embodiments are related to systems and methods of transmission of end-to-end (E2E) user plane traffic between two remote user equipments (UEs) via a relay-UE. The relay-UE, as described herein, may be a layer-2 (L2) U2U relay. The L2 U2U relay may be referenced in the present disclosure as a relay-UE, and may be communicatively coupled with a remote UE via a PC5 interface that enables transmission of end-to-end (E2E) user plane traffic (or communication) via the relay-UE, without requiring a base station or a network (e.g., a core network). However, for the transmission of E2E user plane traffic between two remote UEs, a protocol stack at the remote UE may need to include and use a sidelink relay adaption protocol (SRAP) layer, which is above a radio link control (RLC) layer of the protocol stack. Accordingly, in a multi-hop UE to UE communication using the PC5 interface, the relay-UE may need to map various fields or parameters in a SRAP header of an ingress RLC channel of a PC5 interface (PC5 RLC channel) traffic to an egress PC5 RLC channel traffic towards a target (or a destination) UE. Further, a remote UE may need to select a L2 U2U relay that may enable transmission of E2E user plane traffic to the destination UE with a lesser number of hops. The remote UE may select the relay-UE by determining an egress PC5 RLC channel or a logical channel identification (LCID) towards the relay-UE.

While a relay-UE enables transmission of E2E user plane traffic for U2U relay scenarios without involvement from a base station and/or a radio access network, in a scenario of a UE-to-network (U2N) relay, RLC layer configurations to support E2E user plane traffic over a Uu interface data radio bearer (DRB) in both a PC5 hop and a Uu hop is provided by a base station using dedicated radio resource control (RRC) signaling. In a case of a relay-UE for U2U relay scenarios, a base station is not involved, and various embodiments described herein may provide details of configuring a PC5 RLC channel.

Further, mapping of PC5 data packets to be transmitted over a particular sidelink data radio bearer (SL-DRB) is based on a mapping of a respective PC5 quality of service (QoS) flow and a SL-DRB. The mapping of the respective PC5 QoS flow and the SL-DRB is based on a PC5 QoS flow identification (PFI), and configured at the UE using a PC5 radio resource control (PC5-RRC) signaling, for example, using a RRCReconfigurationSidelink message, the RRCReconfigurationSidelink RRC message configures a PC5 RLC channel (also known as and referenced herein as a PC5 Relay RLC channel) for a corresponding LCID and sequence number (SN) size, and QoS related parameters for a service data adaption protocol (SDAP) layer of the UE protocol stack. The SDAP layer may only be present in a protocol stack of a remote UE, but not a relay-UE. Accordingly, a PFI that is configured at the SDAP layer may not be relevant or available for the relay-UE for QoS configuration for an ingress PC5 RLC channel and/or an egress PC5 RLC channel at the relay-UE. Various embodiments described herein may provide details of configuring a relay-UE and/or a remote UE for transmission of E2E user plane traffic via a SL-DRB, and in accordance with the E2E QoS for a first PC5 hop between a remote UE (e.g., S-Remote UE) and a relay-UE, and a second PC5 hop between the relay-UE and the remote UE (e.g., T-Remote UE). Further, various embodiments described herein also provide details of configuring a PC5 RLC channel to support E2E signaling in a sidelink signaling radio bearer (SL-SRB).

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

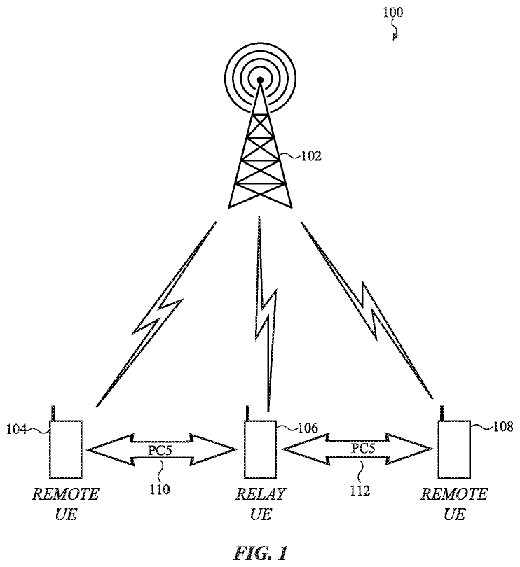

FIG. 1 shows an example wireless communication system, according to embodiments described herein. As shown in FIG. 1, a wireless communication system 100 may include base station 102, at least two UEs 104 and 108, and a relay-UE 106. The at least UEs 104 and 108 may be referred to herein as remote UEs 104 and 108. Further, a remote UE transmitting E2E user plane traffic towards another remote UE may be referenced herein as a S-Remote UE, and the other remote UE receiving the E2E user plane traffic from the S-Remote UE via a relay-UE may be referenced herein as a T-Remote UE. Accordingly, the UE 104 may act as a S-Remote UE and/or a T-Remote UE based on whether the UE 104 is transmitting or receiving E2E user plane traffic via the relay-UE 106. Similarly, the UE 108 may act as a S-Remote UE and/or a T-Remote UE based on whether the UE 104 is transmitting or receiving E2E user plane traffic via the relay-UE 106.

The E2E user plane traffic between the UEs 104 and 108 is exchanged via the relay-UE 106, and without a need of the base station 102 and/or radio access network services from the base station 102. Each of the UEs 104 and 108 may be communicatively coupled with the relay-UE 106 via a PC5 interface (or a sidelink interface) 110 and a PC5 interface 112, respectively. The PC5 interface between a UE and a relay-UE may include a PC5 RLC channel. Using the PC5 RLC channel, a SL-SRB may be established between the UE and the relay-UE for exchange of control or signaling messages. Based on exchange of signaling messages via the SL-SRB, a SL-DRB may be established between the UE and the relay-UE for carrying E2E user plane traffic according to a QoS for the E2E user plane traffic, as requested by the UE.

As described herein, in some embodiments, a PC5 RLC channel between a remote UE (e.g., the UE 104 or the UE 108) and a relay-UE (e.g., the relay-UE 106) is established in response to discovery of a relay-UE by the remote UE. The relay-UE may be discovered by the remote UE using discovery messages generated and sent using a physical sidelink discovery channel (PSDCH) or a physical sidelink shared channel (PSSCH) message. Upon discovery of the relay-UE, a PC5 RLC channel between the remote UE and the relay-UE may be established according to a configuration for a PC5 RLC channel for a sidelink relay. The configuration for the PC5 RLC channel for the sidelink relay may be provided to the UE which is transmitting E2E user plane traffic via a sidelink data radio bearer (SL-DRB). In other words, the configuration for the PC5 RLC channel may be provided to the S-Remote UE and the relay-UE. The S-Remote UE is transmitting E2E user plane traffic to the relay-UE, and the relay-UE is forwarding the E2E user plane traffic to a T-Remote UE.

In some embodiments, the configuration for the PC5 RLC channel may include a RLC channel index, a RLC configuration, a logical channel (LCH) configuration, and a packet delay budget (PDB) parameter configuration. The RLC channel index may identify a particular PC5 RLC channel, and thereby, a particular relay-UE and/or a T-Remote UE to which E2E user plane traffic may be transmitted. By way of a non-limiting example, the RLC channel index may have an association with a logical channel identification (LCID) of a RLC channel.

The RLC configuration may include details of a mode of a RLC channel (or a RLC mode), a configuration for the RLC mode, and a SN length or a SN size. The RLC mode may be any of a transparent mode (TM), an unacknowledged mode (UM), and an acknowledge mode (AM). The configuration corresponding to the RLC mode may include constants (e.g., AM_Window_Size, UM_Window_Size), timers (e.g., t-PollRetransmit, t-Reordering), configurable parameters (e,g, maxRetxThreshold, pollPDU, pollByte), and so on. The RLC configuration may also include whether a RLC channel is associated with uni-directional traffic or bi-directional traffic. The RLC configuration may also include the supported SN size to be used for the RLC channel.

The LCH configuration may include a priority of a logical channel (a LCH priority), a bit rate corresponding to the LCH priority (a PriorityBitRate), bucket size duration (BSD) corresponding to the PriorityBitRate, and/or a hybrid automatic repeat request feedback (HARQ-FB) mode. The PDB parameter configuration may be configured by a base station when a relay-UE is a relay in a U2N relay scenario. For the U2U relay scenario, the relay-UE may determine how to split a PDB based on the PDB parameter configuration, which may be received from another UE, which may be acting as a relay-UE. By way of a non-limiting example, the PDB parameter configuration may be received from a base station (acting as a relay-UE), and/or a network. The PDB parameter is a dynamic parameter, and its value may change dynamically. The PDB parameter value may be selected from a set of PDB parameter values.

For the PC5 RLC channel or a RLC channel to work as a sidelink (SL), a S-Remote UE and a T-Remote UE/relay-UE may need to agree on a SN size and a LCID.

In some embodiments, the base station 102 may be an eNb, an eNodeB, a gNodeB, or an access point (AP) in a RAN and may support one or more radio access technologies, such as 4G, 5G, 5G new radio (5G NR), and so on. The UEs 104 and/or 108, and/or the relay-UE 106 may be a phone, a smart phone, a tablet, a smartwatch, an Internet-of-Things (IoT) device, a vehicle, and so on.

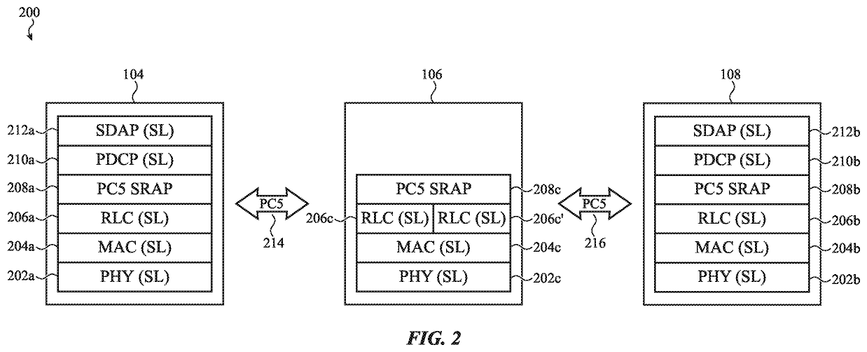

In some embodiments, for transmission of E2E user plane traffic via a relay-UE, a S-Remote UE and a T-Remote UE need to establish E2E signaling bearer and E2E data bearer. The S-Remote UE, the T-Remote UE, and the relay-UE may have a respective protocol stack, as described herein using FIG. 2.

FIG. 2 illustrates an example of U2U protocol stacks, according to embodiments described herein. As shown in a view 200 of FIG. 2, the UE 104, the UE 108, and the relay-UE 106 may have a respective protocol stack for supporting a SL interface (or a PC5 interface). The protocol stacks for the UE 104 and the UE 108 may include layers (from bottom to top): a physical layer for a SL interface (PHY (SL)) 202a and 202b, a media access controller for the SL interface (MAC (SL)) 204a and 204b, a radio link control layer for the SL interface (RLC (SL)) 206a and 206b, a PC5 SRAP layer 208a and 208b, a packet data convergence protocol layer for the SL interface (PDCP (SL)) 210a and 210b, and a SDAP layer for the SL interface (SDAP (SL)) 212a and 212b.

Further, as shown in the view 200, the protocol stack for the relay-UE 106 may not include PDCP (SL) and SDAP (SL) layers. The protocol stack for the relay-UE 106 may include a PHY (SL) 202c, a MAC (SL) 204c, an ingress RLC (SL) 206c and an egress RLC (SL) 206c′, and a PC5 SRAP layer 208c.

As described herein, the E2E signaling bearer and the E2E data bearer for the SL interface may be established between the relay-UE 106 and the UE 104, and between the relay-UE 106 and the UE 108 using a PC5 RLC channel 214 and a PC5 RLC channel 216, respectively. The relay-UE 106 may receive PC5 RLC channel traffic from the UE 104 (or an ingress PC5 RLC channel traffic) and may transmit as PC5 RLC channel traffic to the UE 108 (or an egress PC5 RCL channel traffic) using the PC5 SRAP layer 208c. The SRAP layer 208c thus selects a particular RLC channel as an egress RLC channel. The egress RLC channel is selected based on the received ingress PC5 RLC channel traffic to send E2E user plane traffic to the destination remote UE (or the T-Remote UE).

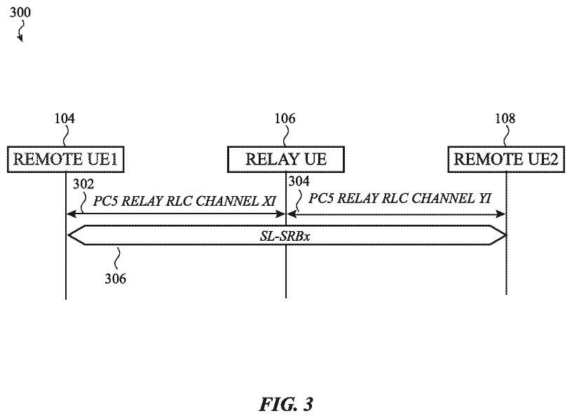

FIG. 3 illustrates an example message flow between remote UEs via a U2U relay-UE for transmission of end-to-end (E2E) user plane traffic, according to embodiments described herein. As shown in FIG. 3 and in an example message flow 300, before E2E user plane traffic can be received and transmitted via a relay-UE, E2E link setup and E2E bearer setup has to be completed. As shown in the message flow 300, E2E user plane traffic between a remote UE1 (or UE1 104) and a remote UE2 (or the UE2 108) is achieved via a relay-UE (or the relay-UE 106). Upon discovery of the relay-UE, a PC5 RLC channel 302 is established between the remote UE1 and the relay-UE, and a PC5 RLC channel 304 is established between the remote UE2 and the relay-UE. An E2E link setup or E2E sidelink signaling radio bearer (SL-SRB) 306 may be established between the remote UE1 104 and the remote UE2 108.

In some embodiments, the SL-SRB 306 may correspond to one or more of E2E SL-SRB0, E2E SL-SRB1, E2E SL-SRB2, and/or E2E SL-SRB3. Each E2E SL bearer including SL-SRB0, SL-SRB1, SL-SRB2, and/or SL-SRB3 may be established based on mapping rules and configurations, which may be a default configuration and/or a fixed (or hard-coded) configuration. Further, each E2E SL bearer may have a corresponding RLC channel based on either a mapping rule or a default configuration, as shown in the table below.

TABLE 1

| E2E SL | | |
|---|---|---|
| Bearer | S-Remote UE to Relay-UE | Relay-UE to T-Remote UE |
| SL-SRB0 | SL-U2U-RLC0 (AM), | SL-U2U-RLC0 (AM), |
| | SN Length = 12 | SN Length = 12 |
| SL-SRB1 | SL-U2U-RLC1 (AM), | SL-U2U-RLC1 (AM), |
| | SN Length = 12 | SN Length = 12 |
| SL-SRB2 | SL-U2U-RLC2 (AM), | SL-U2U-RLC2 (AM), |
| | SN Length = 12 | SN Length = 12 |
| SL-SRB3 | SL-U2U-RLC3 (AM), | SL-U2U-RLC3 (AM), |
| | SN Length = 12 | SN Length = 12 |

Mapping of an E2E SL bearer with a corresponding PC5 RLC channel between the S-Remote UE and the relay-UE, and the relay-UE and the T-Remote UE in the table above is for example only. An E2E SL bearer may be mapped to a different RLC channel than shown in the table above, and may have a different RLC mode and/or SN length.

In some embodiments, one or more indexes providing a LCID value may be updated for transmission of the E2E user plane traffic via a relay-UE. For example, an index value 52 may correspond with a LCID value for SCCH carrying E2E SL-SRB0 messages delivered via SL-U2U-RLC0. Similarly, an index value 53 may correspond with a LCID value for SCCH carrying E2E SL-SRB1 messages delivered via SL-U2U-RLC1, an index value 54 may correspond with a LCID value for SCCH carrying E2E SL-SRB2 messages delivered via SL-U2U-RLC2, and an index value 55 may correspond with a LCID value for SCCH carrying E2E SL-SRB3 messages delivered via SL-U2U-RLC3. Further, index values 56 and 57 may correspond with a LCID value for SCCH carrying RRC messages delivered via SL-RLC0 and a LCID value for SCCH carrying RRC messages delivered via SL-RLC1, as specified in 3rd Generation Partnership Project (3GPP) Technical Specification (TS) 38.331. An index value 58 may correspond with a LCID value for SCCH for sidelink discovery messages. The index values for various LCID values are described herein for example, and a different index value than described herein may be used for a particular LCID value.

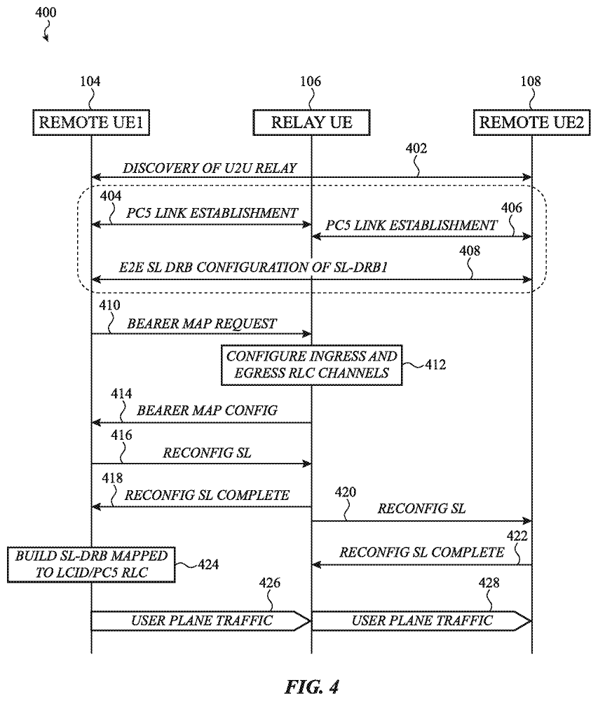

Thus, a remote UE (S-Remote UE) may discover a relay-UE for transmission of E2E user plane traffic with another remote UE (T-Remote UE), and each of the S-Remote UE and the T-Remote UE may establish a PC5 link (or a PC5 RLC channel) with the relay-UE. As described herein, upon establishment of a PC5 link between the S-Remote UE and the relay-UE, and/or the T-Remote UE and the relay-UE, one or more E2E SL-SRBs may be established using SL-U2U-RLC0, SL-U2U-RLC1, SL-U2U-RLC2, and/or SL-U2U-RLC3 as shown in Table 1. Using the one or more E2E SL-SRBs, the S-Remote UE and the T-Remote UE may set up E2E SL-DRBs for transmission of E2E user plane traffic, and security and QoS for the E2E user plane traffic. An example message flow for transmission of the E2E user plane traffic, and E2E QoS for each PC5 hop between the S-Remote UE and the T-Remote UE, is described using FIG. 4.

FIG. 4 illustrates an example message flow corresponding to configuration of a radio link control (RLC) channel of a PC5 interface (PC5 RLC channel) between a remote UE and a U2U relay-UE, according to embodiments described herein, as shown in an example message flow 400 between a remote UE1 (the S-Remote UE, such as the UE 104), a remote UE2 (the T-Remote UE, such as the UE 108), and a relay-UE (such as the relay-UE 106). As shown in the message flow 400, the S-Remote UE and/or the T-Remote UE may perform discovery of a relay-UE (also referenced herein as a L2 U2U relay or a U2U relay) 402. The S-Remote UE and/or the T-Remote UE may discover the relay-UE using a relay discovery message in any of RRC_IDLE, RRC_INACTIVE, and/or RRC_CONNECTED states of the S-Remote UE and/or the T-Remote UE.

At 404, a PC5 link between the S-Remote UE and the relay-UE discovered at 402 may be established, and at 406, a PC5 link between the relay-UE discovered at 402 may be established. During the link establishment for the U2U relay purpose, the RLC entity using the default PC5 RLC channel configurations can be established in a Remote UE 104 and/or Remote UE 108, and in the relay-UE 106. The automatic establishment of a PC5 RLC channel between RLC entities of the Remote UE 104 and/or Remote UE 108, and the relay-UE 106 may be based on a default configuration and/or a mapping as described herein in Table 1. The two RLC channels, e.g., one RLC channel between the Remote UE 1 and the relay-UE, and another RLC channel between the relay-UE and the Remote UE 2, may be used to support one or more E2E SL-SRB between the Remote UE 1 and the Remote UE 2. By way of a non-limiting example, multiple different PC5 Relay RLC channels to support different E2E SL-SRBs, for example, SL-U2U-RLC0, SL-U2U-RLC1, SL-U2U-RLC2, and/or SL-U2U-RLC3, and so on, as described in Table 1 may also be established. Thus, one or more E2E SL-SRBs and one or more E2E SL-DRBs may be established between the S-Remote UE and the T-Remote UE via the relay-UE by using the PC5 Relay RLC channels to transport E2E traffic corresponding the one or more E2E SL-SRBs, which is shown as 408. The E2E SL-SRB and the E2E SL-DRB may have a corresponding default PC5 RLC channel having a respective default configuration for the PC5 RLC channel. In FIG. 4, only one E2E SL-DRB is shown between the Remote UEs 104 and 108. However, more than one E2E SL-DRBs may also be established in some embodiments.

However, the E2E SL-DRB that is using default PC5 RLC channels for relay may not meet QoS requirements. Accordingly, the E2E SL-DRB may need to be updated to ensure QoS over the E2E SL-DRB for each hop between the S-Remote UE and the T-Remote UE. In a more general case, an E2E SL-DRB may not have a supporting PC5 RLC channel to use with the exception of a default PC5 RLC channel, and one or more PC5 RLC channels to be used by to relay the E2E SL-DRB may initially need to be created. The respective configuration to ensure the QoS over the E2E SL-DRB as required for a particular QoS flow associated with the E2E user plane traffic may be received by the S-Remote UE and/or the T-Remote UE from the relay-UE after a PC5 RLC channel is established with the relay-UE. The reconfiguration of the E2E SL-DRB may be performed using an exchange of messages shown in the example message flow 400 as 410-422. In other words, to ensure the QoS over the E2E SL-DRB, the S-Remote UE and/or the T-Remote UE need a PC5 RLC channel configuration that can support the QoS required for the QoS flow of the associated E2E user plane traffic.

In some embodiments, and by way of a non-limiting example, the relay-UE may provide the S-Remote UE and/or the T-Remote UE the PC5 RLC channel configuration upon establishment of a PC5 link at 404 and/or 406. Alternatively, or additionally, the PC5 RLC channel configuration may be preconfigured at the S-Remote UE, the T-Remote UE, and/or the relay-UE using a RRC signaling or a system information block (SIB). However, when the PC5 RLC channel configuration is preconfigured using a SIB and/or a RRC signaling, a total number of different PC5 RLC channel configurations that can be preconfigured may be limited to a few possible PC5 RLC channel configurations, and may not provide all possible PC5 RLC channel configurations for pre-configuration.

As shown in FIG. 4 as 410, the S-Remote UE may send a BearerMapRequest message to the relay-UE. Since the E2E SL-DRB needs to be updated based on a specific PC5 RLC channel configuration to meet a particular QoS corresponding to a QoS flow associated with the E2E user plane traffic, the S-Remote UE may include in the BearerMapRequest message information regarding an E2E SL-DRB that is to be reconfigured, and/or QoS information. In some embodiments, and by way of a non-limiting example, the S-Remote UE may request PC5 RLC channel configurations for more than one E2E SL-DRB in a single BearerMapRequest message. In some examples, SDAP information for QoS may also be included in the BearerMapRequest message. The SDAP information for QoS may indicate which E2E flows are being mapped to the E2E SL-DRB specified in the BearerMapRequest message. In some embodiments, the BearerMapRequest message may be transmitted after the required PC5 RLC channel has been established, for example, via ReconfigSL and ReconfigSLComplete in steps 416, 418, 420, and 422. Accordingly, in such cases, the remote UE and the relay-UE may establish all possible PC5 Relay RLC channels blindly without knowing which SL-DRBs are supported, and which PC5 Relay RLC channels will be actually used to support user plane traffic in E2E SL-DRB.

At 412, the relay-UE may determine a PC5 RLC channel configuration for a PC5 RLC channel between the relay-UE and the S-Remote UE (or an ingress PC5 RLC channel at the relay-UE), which is a first hop of the E2E user plane traffic between the S-Remote UE and the T-Remote UE via the relay-UE. The relay-UE may also determine a PC5 RLC channel configuration for a PC5 RLC channel between the relay-UE and the T-Remote UE (or an egress PC5 RLC channel at the relay-UE), which is a second hop of the E2E user plane traffic between the S-Remote UE and the T-Remote UE via the relay-UE. The relay-UE may also determine one or more priority parameters and their values for the ingress PC5 RLC channel and/or the egress PC5 RLC channel. The one or more priority parameters and their values may be determined based on PC5 QoS identifier (PQI) information included in the QoS information in the BearerMapRequest message. The relay-UE may also determine a PDB split between corresponding to the QoS information. In other words, packet delay information for data packets according to the QoS information may be determined and included in a PC5 RLC channel configuration.

As described herein, QoS of SL may be determined according to the PQI. The PQI may also be known as PC5 5QI, and may be associated with at least priority, PDB, and packet error rate (PER) requirements. To ensure QoS for the E2E SL-DRB, the relay-UE may be configured to determine the priority, the PDB, and the PER for each hop based on an algorithm. One example of the algorithm may suggest that for QoS of E2E SL-DRB having a PQI of m with a PDB of X, a priority of Y, and a PER of E, a PDB for all hops of the E2E SL-DRB when added together cannot exceed the PDB of X. Similarly, a priority for any hop of the E2E SL-DRB cannot exceed the priority Y, and a PER for all hops of the E2E SL-DRB when multiplied cannot exceed the PER E.

At 414, the relay-UE may transmit to the S-Remote UE a PC5 RLC channel configuration for the ingress PC5 RLC channel for the relay-UE in a BearerMapConfig message. The relay-UE may determine and indicate in the PC5 RLC channel configuration whether an existing PC5 RLC channel can be reused to support the E2E SL-DRB. If the existing PC5 RLC channel cannot be reused to support the E2E SL-DRB, a new PC5 RLC channel may be created. A mapping of the PC5 RLC channel and the E2E SL-DRB may be updated. The PC5 RLC channel configuration sent to the S-Remote UE may be identified using an index. Further, the PC5 RLC channel configuration may also include the PDB information for the E2E SL-DRB. While a configuration for the ingress PC5 RLC channel is sent to the S-Remote UE at 414, a configuration for the egress PC5 RLC channel may be kept by the relay-UE itself. In some embodiments, the BearerMapConfig message may be transmitted after the required PC5 RLC channels are established, for example, via ReconfigSL and ReconfigSLComplete. Accordingly, the LCID(s) may already be known to the remote UEs and the relay UE, and the relay UE may use an LCID to indicate the mapping directly, instead of using an index of PC5 RLC channel configuration.

At 416, the S-Remote UE may reconfigure the sidelink by performing a RRCReconfigurationSidelink procedure by transmitting a ReconfigSL message with the relay-UE. The ReconfigSL message may specify a LCID and a SN size based on the configuration of the ingress PC5 RLC channel received from the relay-UE at 414. The ReconfigSL message may also include one or more SL-U2U-RLC-Channel-IEs. Upon completion of the reconfiguration by the relay-UE, at 418, the relay-UE may transmit a ReconfigSLComplete message to the S-Remote UE.

At 420, the relay-UE may request reconfiguration of the sidelink by performing a RRCReconfigurationSidelink procedure by transmitting a ReconfigSL message to the T-Remote UE. The ReconfigSL message may specify a LCID and a SN size based on the configuration of the egress PC5 RLC channel. The ReconfigSL message may also include one or more SL-U2U-RLC-Channel-IEs. Upon completion of the reconfiguration by the T-Remote UE, at 422, the T-Remote UE may transmit a ReconfigSLComplete message to the relay-UE. In some embodiments, an exchange of ReconfigSL and ReconfigSLComplete shown as 416, 418, 420, and 422 may be performed before BearerMapConfig message 414. As a result, the LCID(s) may be already known by the remote UEs and the relay-UE, and the relay-UE may use the LCID to indicate the mapping directly in the BearerMapConfig message 414, instead of using an index of a PC5 RLC channel configuration.

At 424, the S-Remote UE may build and/or update a mapping of the E2E SL-DRB and a corresponding LCID and/or PC5 RLC channel. In particular, the S-Remote UE may set a bearer identification (a Bearer ID) in a header of a SRAP layer message to the E2E SL-DRB, and place E2E user plane traffic to the configured PC5 RLC channel of the configured LCID in MAC sub-header. The mapping at 424 may then be used by the S-Remote UE to send E2E user plane traffic over the E2E SL-DRB associated with a specific PC5 RLC channel (or a LCID) to the relay-UE, which is shown as 426. The relay-UE would similarly relay forward the E2E user plane traffic to the T-Remote UE, which is shown as 428.

In some embodiments, the E2E SL-DRB may be a unidirectional SL-DRB or a bidirectional SL-DRB. In the bidirectional SL-DRB, the S-Remote UE and the T-Remote UE may generate traffic with the same Bearer ID in a header of the SRAP layer message. Accordingly, the S-Remote UE and the T-Remote UE may be able to associate the traffic with a correct PDCP entity. For example, a PDCP control protocol data unit (PDU), such as a robust header compression (ROHC) feedback, sent by one UE may be associated with the PDCP traffic in the other direction correctly by the peer UE. In the unidirectional SL-DRB, the S-Remote UE and the T-Remote UE may generate traffic using a different Bearer ID in a header of the SRAP layer message. In some embodiments, E2E LCID information may not be required for the E2E user plane traffic over-the-air.

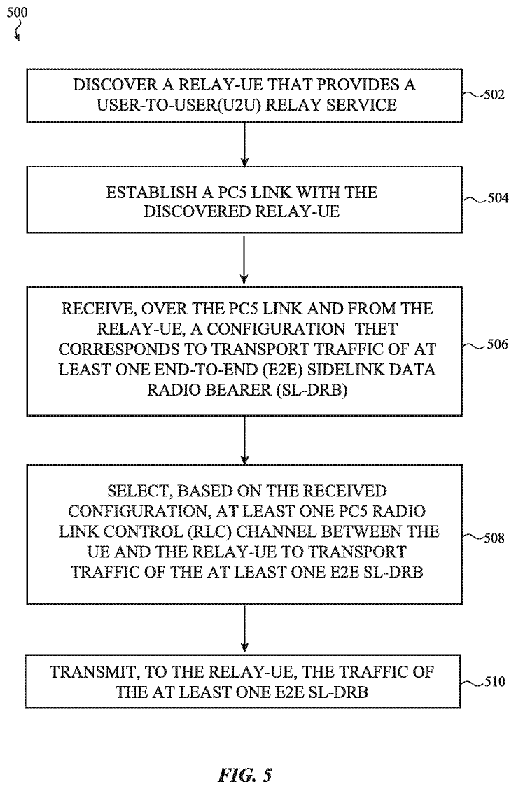

FIG. 5 illustrates an example flow-chart of operations that may be performed by a UE (or a remote UE), according to embodiments described herein. As shown in a flow-chart 500, at 502, a UE (e.g., a S-Remote UE) may discover a relay-UE providing a U2U relay service. As described herein. a relay-UE providing the U2U relay service may enable transmission of user plane traffic without requiring a base station and/or a network. At 504, in response to discovery of the relay-UE, a PC5 link of a PC5 interface (or a PC5 RLC channel) may be established between the UE and the relay-UE. Upon establishment of the PC5 link, a default PC5 RLC channel may be established to carry out at least E2E SL-SRB(s) and/or E2E SL-DRB(s) for a U2U relay scenario.

At 506, a configuration corresponding to at least one SL-DRB for transmission of E2E user plane traffic according to a QoS that is required and/or requested by the UE may be received. As described herein, the E2E SL-DRB may need to be updated or configured to ensure QoS over the E2E SL-DRB for each hop between the UE and another UE (e.g., a T-Remote UE). The respective configuration to ensure the QoS over the E2E SL-DRB as required for a particular QoS flow associated with the E2E user plane traffic may be received by the UE from the relay-UE after a PC5 link is established with the relay-UE.

At 508, using the configuration corresponding to transport of traffic of the at least one E2E SL-DRB, at least one PC5 RLC channel is selected between the UE and the relay-UE to transport traffic of the at least one E2E SL-DRB to another UE. In other words, the reconfiguration of the at least one PC5 Relay RLC channel and related QoS parameters between the remote UE and the relay-UE may be performed to ensure the QoS over the E2E SL-DRB. The reconfiguration of the at least one SL-DRB is described in detail using FIG. 4 above, and hence those details are not repeated for brevity.

At 510, the UE may transmit, to the relay-UE, the E2E user plane traffic via the at least one SL-DRB. Since transmission of the user plane traffic is described in detail above using FIG. 4 above, these details are not repeated again. In the present disclosure, the E2E user plane traffic and the E2E SL-DRB may be used interchangeably.

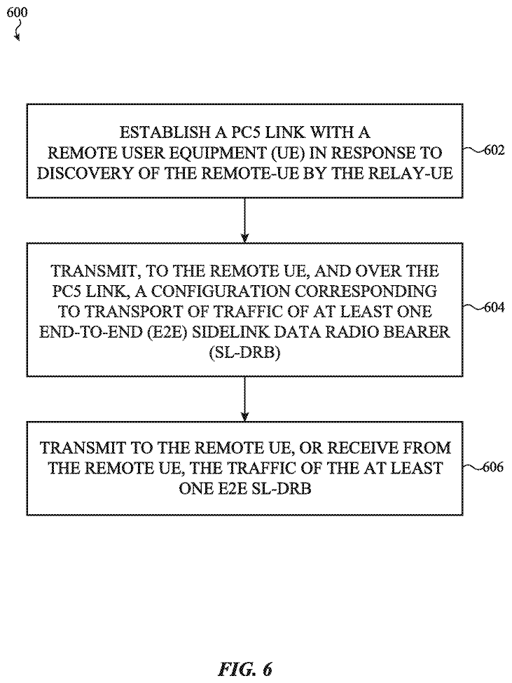

FIG. 6 illustrates an example flow-chart of operations that may be performed by a relay-UE (or a U2U relay-UE), according to embodiments described herein. As shown in a flow-chart 600, at 602, a PC5 link may be established between a UE or a remote UE (e.g., a S-Remote UE, a T-Remote UE) and the relay-UE. The PC5 link may be established in response to a discovery of the remote UE by the relay-UE. Upon PC5 link establishments, a PC5 RLC channel, e.g., using a default PC5 RLC channel configuration, may be established to at least support the transport of E2E SL-SRB and/or E2E SL-DRB traffic for U2U relay scenario.

At 604, a configuration corresponding to at least one SL-DRB for transmission of E2E user plane traffic according to a QoS that is required and/or requested by the remote UE may be transmitted to the remote UE. As described herein, the E2E SL-DRB may need to be updated to ensure QoS over the E2E SL-DRB for each hop between the UE and another UE (e.g., a T-Remote UE). The respective configuration to ensure the QoS over the E2E SL-DRB as required for a particular QoS flow associated with the E2E user plane traffic may be transmitted to the remote UE from the relay-UE after a PC5 link is established between the remote UE and the relay-UE.

At 606, the relay-UE may transmit to the remote UE, or receive from the remote UE, the E2E user plane traffic via the at least one E2E SL-DRB that is reconfigured or updated based on the configuration transmitted to the remote UE at 604. Since transmission of the user plane traffic is described in detail above using FIG. 4 above, these details are not repeated again.

Embodiments contemplated herein include one or more non-transitory computer-readable media storing instructions to cause an electronic device, upon execution of the instructions by one or more processors of the electronic device, to perform one or more elements of the method 500, or 600. In the context of method 500, or 600, this non-transitory computer-readable media may be, for example, a memory of a UE (such as a memory 806 of a wireless device 802 that is a UE, as described herein). In the context of method 500, or 600, this non-transitory computer-readable media may be, for example, a memory of a base station, or a relay-UE (such as a memory 824 of a network device 820 that is a base station, as described herein).

Embodiments contemplated herein include an apparatus having logic, modules, or circuitry to perform one or more elements of the method 500, or 600. In the context of method 500, or 600, this apparatus may be, for example, an apparatus of a UE (such as a wireless device 802 that is a UE, as described herein). In the context of method 500, or 600, this apparatus may be, for example, an apparatus of a base station or a relay-UE (such as a network device 820 that is a base station, as described herein).

Embodiments contemplated herein include an apparatus having one or more processors and one or more computer-readable media, using or storing instructions that, when executed by the one or more processors, cause the one or more processors to perform one or more elements of the method 500, or 600. In the context of method 500, or 600, this apparatus may be, for example, an apparatus of a UE (such as a wireless device 802 that is a UE, as described herein). In the context of the method 500, or 600, this apparatus may be, for example, an apparatus of a base station or a relay-UE (such as a network device 820 that is a base station, as described herein).

Embodiments contemplated herein include a signal as described in or related to one or more elements of the method 500, or 600.

Embodiments contemplated herein include a computer program or computer program product having instructions, wherein execution of the program by a processor causes the processor to carry out one or more elements of the method 500, or 600. In the context of method 500, or 600, the processor may be a processor of a UE (such as a processor(s) 804 of a wireless device 802 that is a UE, as described herein), and the instructions may be, for example, located in the processor and/or on a memory of the UE (such as a memory 806 of a wireless device 802 that is a UE, as described herein). In the context of method 500, or 600, the processor may be a processor of a base station or a relay-UE (such as a processor(s) 822 of a network device 820 that is a base station, as described herein), and the instructions may be, for example, located in the processor and/or on a memory of the base station (such as a memory 824 of a network device 820 that is a base station, as described herein).

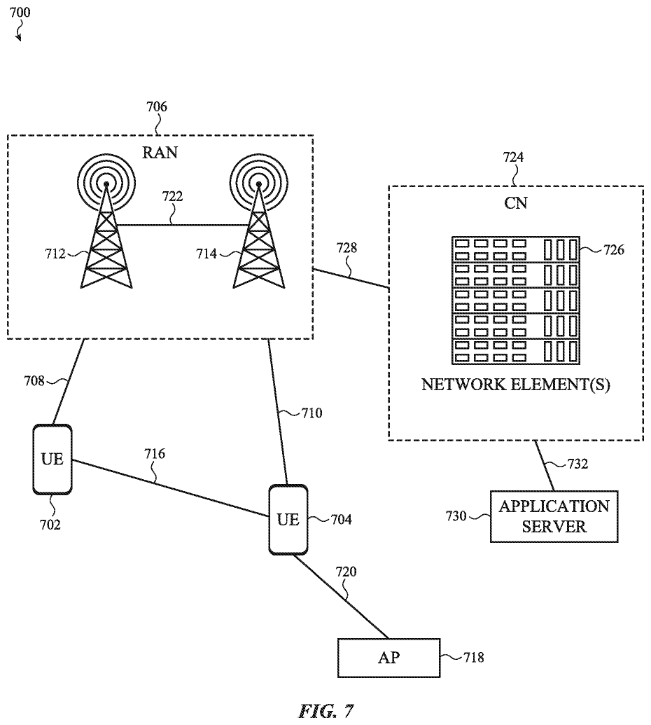

FIG. 7 illustrates an example architecture of a wireless communication system, according to embodiments described herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations, such as base station 712 and base station 714, that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 800 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 724 is a 5GC), the interface 722 may be an Xn interface. The Xn interface is defined between two or more base stations (e.g., two or more gNBs and the like) that connect to the 5GC, between a base station 712 (e.g., a gNB) connecting to the 5GC and an eNB, and/or between two eNBs connecting to the 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

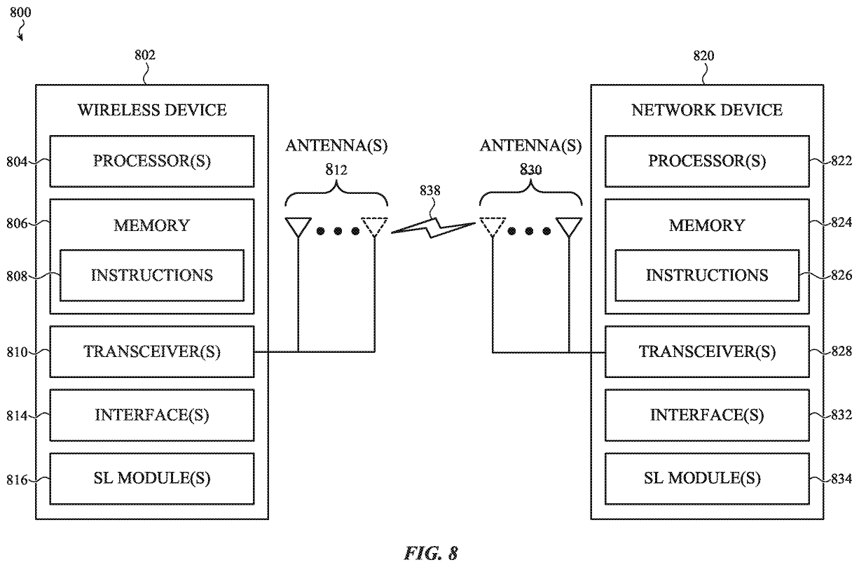

FIG. 8 illustrates a system 800 for performing signaling 838 between a wireless device 802 and a network device 820, according to embodiments described herein. The system 800 may be a portion of a wireless communication system as herein described. The wireless device 802 may be, for example, a UE of a wireless communication system. The network device 820 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 838) to and/or from the wireless device 802 with other devices (e.g., the network device 820) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include an SL module 816. The SL module 816 may be implemented via hardware, software, or combinations thereof. For example, the SL module 816 may be implemented as a processor, circuit, and/or instructions 808 stored in the memory 806 and executed by the processor(s) 804. In some examples, the SL module 816 may be integrated within the processor(s) 804 and/or the transceiver(s) 810. For example, the SL module 816 may be implemented by a combination of software components (e.g., executed by a DSP or a general processor) and hardware components (e.g., logic gates and circuitry) within the processor(s) 804 or the transceiver(s) 810.

The SL module 816 may be used for various aspects of the present disclosure, for example, aspects of FIGS. 1-6, from a remote UE perspective.

The network device 820 may include one or more processor(s) 822. The processor(s) 822 may execute instructions such that various operations of the network device 820 are performed, as described herein. The processor(s) 822 may include one or more baseband processors implemented using, for example, a CPU, a DSP, an ASIC, a controller, an FPGA device, another hardware device, a firmware device, or any combination thereof configured to perform the operations described herein.

The network device 820 may include a memory 824. The memory 824 may be a non-transitory computer-readable storage medium that stores instructions 826 (which may include, for example, the instructions being executed by the processor(s) 822). The instructions 826 may also be referred to as program code or a computer program. The memory 824 may also store data used by, and results computed by, the processor(s) 822.

The network device 820 may include one or more transceiver(s) 828 that may include RF transmitter and/or receiver circuitry that use the antenna(s) 830 of the network device 820 to facilitate signaling (e.g., the signaling 838) to and/or from the network device 820 with other devices (e.g., the wireless device 802) according to corresponding RATs.

The network device 820 may include one or more antenna(s) 830 (e.g., one, two, four, or more). In embodiments having multiple antenna(s) 830, the network device 820 may perform MIMO, digital beamforming, analog beamforming, beam steering, etc., as has been described.

The network device 820 may include one or more interface(s) 832. The interface(s) 832 may be used to provide input to or output from the network device 820. For example, a network device 820 that is a base station may include interface(s) 832 made up of transmitters, receivers, and other circuitry (e.g., other than the transceiver(s) 828/antenna(s) 830 already described) that enables the base station to communicate with other equipment in a network, and/or that enables the base station to communicate with external networks, computers, databases, and the like for purposes of operations, administration, and maintenance of the base station or other equipment operably connected thereto.

The network device 820 may include an SL module 834. The SL module 834 may be implemented via hardware, software, or combinations thereof. For example, the SL module 834 may be implemented as a processor, circuit, and/or instructions 826 stored in the memory 824 and executed by the processor(s) 822. In some examples, the SL module 834 may be integrated within the processor(s) 822 and/or the transceiver(s) 828. For example, the SL module 834 may be implemented by a combination of software components (e.g., executed by a DSP or a general processor) and hardware components (e.g., logic gates and circuitry) within the processor(s) 822 or the transceiver(s) 828.

The SL module 834 may be used for various aspects of the present disclosure, for example, aspects of FIGS. 1-6, from a relay-UE perspective.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

We claim:

1. A user equipment (UE), comprising:
a transceiver; and
a processor configured to:
discover a relay-UE that provides a UE-to-UE (U2U) relay service;
establish a PC5 link with the discovered relay-UE;
receive, over the PC5 link and from the relay-UE, a configuration that corresponds to transport traffic of at least one end-to-end (E2E) sidelink data radio bearer (SL-DRB);
select, based on the received configuration, at least one PC5 radio link control (RLC) channel between the UE and the relay-UE to transport traffic of the at least one E2E SL-DRB to another UE; and
transmit, via the transceiver to the relay-UE, the traffic of the at least one E2E SL-DRB.

2. The UE of claim 1, wherein:
the configuration is received in response to a request message sent to the relay-UE from the UE, the request message corresponds to a request for the configuration for transport of the traffic of the E2E SL-DRB and corresponding quality of service (QoS) characteristics; and
the received configuration for transport of the traffic of the at least one SL-DRB comprises:
a RLC channel index;
a RLC configuration;
a logical channel (LCH) configuration; and
a packet delay budget (PDB) parameter configuration.

3. The UE of claim 2, wherein:
the RLC channel index is a logical channel identification (LCID);
the RLC configuration includes at least one of:
a RLC mode;
a configuration corresponding to the RLC mode; or
a sequence number length or a sequence number size; and
the LCH configuration includes at least one of:
a LCH priority;
a bit rate corresponding to the LCH priority (PriorityBitRate);
a bucket size duration (BSD) corresponding to the PriorityBitRate; or
a hybrid automatic repeat request feedback (HARQ-FB) mode.

4. The UE of claim 2, wherein:
to select the at least one PC5 radio link control (RLC) channel between the UE and the relay-UE, the processor is configured to:
determine whether a PC5 RLC channel is established between the UE and the relay-UE; and
in accordance with the PC5 RLC channel not being established between the UE and relay-UE, creating a new PC5 RLC channel between the UE and the relay-UE.

5. The UE of claim 2, wherein:
the UE is in a U2U relay mode; and
the PDB parameter configuration is received from another UE acting as the relay-UE.

6. The UE of claim 2, wherein the PDB parameter configuration corresponds with a value of a PDB parameter that is dynamically selected by the relay-UE from one or more preconfigured or configured PDB parameter values.

7. The UE of claim 2, wherein:
the QoS characteristics correspond with a QoS for a first hop between the UE and the relay-UE for transport of the traffic the E2E SL-DRB; and
the processor is configured to transmit, to the relay-UE and via the transceiver, service data adaptation protocol (SDAP) information, the SDAP information provides a respective mapping of an E2E flow and a SL DRB.

8. The UE of claim 1, wherein the processor is configured to:
prior to establishing the at least one SL-DRB, set up an E2E link, the E2E link corresponds with at least a respective E2E sidelink signaling radio bearer (SL-SRB) associated with a default PC5 RLC channel of multiple default PC5 RLC channels.

9. The UE of claim 1, wherein:
the processor is configured to initiate a radio resource control procedure for reconfiguration of a sidelink (RRCReconfigurationSidelink) to configure a logical channel identification (LCID) and a RLC sequence number size for the at least one SL-DRB of a first hop between the UE and the relay-UE.

10. A relay user equipment (relay-UE), comprising:
a transceiver; and
a processor configured to:
establish a PC5 link with a remote user equipment (UE) in response to discovery of the remote UE by the relay-UE;
transmit, to the remote UE, and over the PC5 link, a configuration corresponding to transport of traffic of at least one end-to-end (E2E) sidelink data radio bearer (SL-DRB); and
transmit to the remote UE, or receive from the remote UE, via the transceiver, the traffic of the at least one E2E SL-DRB.

11. The relay-UE of claim 10, wherein the configuration corresponding to the at least one E2E SL-DRB comprises:
a RLC channel index or a logical channel identification (LCID);
a RLC configuration including at least one of:
a RLC mode;
a configuration corresponding to the RLC mode; or
a sequence number length or a sequence number size;
a logical channel (LCH) configuration including at least one of:
a LCH priority;
a bit rate corresponding to the LCH priority (PriorityBitRate);
a bucket size duration (BSD) corresponding to the PriorityBitRate; or
a hybrid automatic repeat request feedback (HARQ-FB) mode; and
a packet delay budget (PDB) parameter configuration.

12. The relay-UE of claim 10, wherein:
the configuration corresponding to the at least one E2E SL-DRB is determined based on service data adaptation protocol (SDAP) information received from the remote UE, the SDAP information provides a respective mapping of an E2E flow and a SL DRB.

13. The relay-UE of claim 11, wherein:
the PDB parameter configuration corresponds with a value of a PDB parameter that is dynamically selected by the relay-UE from one or more preconfigured or configured PDB parameter values.

14. The relay-UE of claim 10, wherein:
the remote UE is a first remote UE;
the configuration for transport of traffic of the E2E SL-DRB is configuration for an ingress PC5 RLC channel configuration for a first hop between the first remote UE and the relay-UE; and
the processor is configured to generate an egress PC5 RLC channel configuration for transmission of traffic to a second remote UE over a second hop between the relay-UE and the second remote UE, the second remote UE different from the first remote UE.

15. The relay-UE of claim 14, wherein:
the processor is configured to initiate a radio resource control procedure for reconfiguration of a sidelink (RRCReconfigurationSidelink) to configure a logical channel identification (LCID) and a RLC sequence number size for at least one E2E SL-DRB of the second hop between the second remote UE and the relay-UE.

16. A method, comprising:
receiving, by a user equipment (UE), a configuration of a radio link control (RLC) channel of a PC5 interface (PC5 RLC channel), the configuration of the PC5 RLC channel corresponds with end-to-end signaling using at least one sidelink signaling radio bearer (SL-SRB);
transmitting, from the UE to a relay user equipment (relay-UE), a request for a configuration corresponding to at least one sidelink data radio bearer (SL-DRB), the at least one SL-DRB configured to provide end-to-end (E2E) user plane traffic to a remote UE according to a quality of service (QoS) for the E2E user plane traffic requested by the UE;
in response to receiving the configuration corresponding to the at least one SL-DRB, initiating a radio resource control procedure for reconfiguration of a sidelink (RRCReconfigurationSidelink) to configure a logical channel identification (LCID) and a RLC sequence number size for the at least one SL-DRB of a first hop between the UE and the relay-UE; and
transmitting, from the UE to the relay-UE and via the at least one SL-DRB, the E2E user plane traffic that is destined to the remote UE.

17. The method of claim 16, wherein the configuration of the PC5 RLC channel is received by the UE from the relay-UE.

18. The method of claim 16, wherein the configuration of the PC5 RLC channel is preconfigured at the UE by a base station.

19. The method of claim 16, wherein the configuration of the PC5 RLC channel is preconfigured at the UE by a base station using a system information block (SIB) or a dedicated radio resource control (RRC) signaling.

20. The method of claim 16, wherein the at least one SL-DRB is a bidirectional DRB.
